(19) United States
(12) Patent Application Publication
(10) Pub. No.: US 2007/0052798 A1
(43) Pub. Date: Mar. 8, 2007

(54) FILMSCANNER

(75) Inventors: Michael Cieslinski, Unterhaching (DE); Peter Geissler, Munchen (DE)

Correspondence Address: GIFFORD, KRASS, GROH, SPRINKLE & CITKOWSKI, P.C, PO BOX 7021, TROY, MI, 48007-7021, US

(73) Assignee: Arnold & Richter Cine Technik GmbH & co. Betriebs KG, Munich (DE)

(21) Appl. No.: 11/469,992

(22) Filed: Sep. 5, 2006

(30) Foreign Application Priority Data
Sep. 5, 2005 (DE) 10 2005 042 136.9

(51) Int. Cl. H04N 3/40

(52) U.S. Cl. 348/102

(57) ABSTRACT

The invention relates to a film scanner for the optical scanning of a motion picture film and for the generation of corresponding scanned images. The film scanner has an infrared channel for the optical scanning of at least one perforation hole of the motion picture film in an infrared range and for the generation of corresponding infrared image data. The film scanner furthermore has an evaluation device for the evaluation of the infrared image data with respect to the position of the perforation hole and for the generation of at least one corresponding image position correction signal. The invention further relates to a corresponding method.

The invention relates to a film scanner for the optical scanning of a motion picture film and for the generation of corresponding scanned images.

A film scanner of this type serves for the scanning of the image information of an exposed film, for example for the purpose of a digital post-processing. A transmission arrangement having at least three color channels is usually provided for this purpose, with the film stock to be scanned being illuminated on the one side and with an optical receiving system and a light receiver being arranged on the other side. The generation of the scanned images takes place for different visible spectral ranges, typically using a red, a green and a blue color channel (RGB scanning), with the different scanned images usually being recorded sequentially.

The motion picture film is transported intermittently in a film scanner of this type to illuminate and scan the individual image sections—i.e. the individually sequential frames—sequentially. It is desired in this process to scan a sequence of sequential individual image sections without any image shift, in particular without any horizontal image shift (weave) and without any vertical image shift (jitter). The individual image sections should therefore be detected in an unchanging relative position with respect to the film track and with respect to the visual field of the light receiver of the film scanner in order to avoid “jolts” on a later playback of the scanned image sequence.

It is known for this purpose to fix the position of the motion picture film precisely in a position of rest between two transport movements, with usually registration pins engaging into the perforation holes which are provided on both longitudinal sides of the film and serve for the transport of the film by means of a sprocket drum. A mechanical registration of this type, however, results in unwanted wear of the perforation holes. Old film stock can moreover have shrunk or have been cut and pasted so that the mechanical registration using registration pins is no longer possible with the desired precision. The introduction and withdrawal of the registration pins is moreover undesirably time-consuming.

It is therefore also known to detect the actual image position using capacitive or optical methods and to make a corresponding subsequent positioning of the film. However, the desired accuracy is also not always achieved by this.

It is an object of the invention to avoid an image shift in connection with the optical scanning of a motion picture film in a simple manner and with high accuracy.

This object is satisfied by a film scanner having the features of claim 1, and in particular in that the film scanner has an infrared channel for the optical scanning of at least one perforation hole of the motion picture film in an infrared spectral range and for the generation of corresponding infrared image data and in that the film scanner furthermore has an evaluation device for the evaluation of the infrared image data with respect to the position of the perforation hole and for the generation of at least one corresponding image position correction signal.

With the film scanner in accordance with the invention, at least one perforation hole of the film is scanned optically by means of an infrared channel after a transport movement of the motion picture film. In this process, infrared image data are generated which represent the precise position of the scanned perforation hole. The infrared image data are evaluated by means of an evaluation device with respect to the position of the perforation hole in order, where necessary, to generate a corresponding image position correction signal which ultimately corresponds to a deviation of the detected actual position of the perforation hole and thus of the corresponding individual image section for correction with respect to a desired position. If a correction of the determined deviation by means of a micro-displacement of the film, of the optical system used or of the light receiver used is provided, the explained scanning in the infrared preferably takes place before a subsequent generation of the (visible) scanned images.

To achieve particularly high accuracy in the detection of the position of the perforation hole, it is important that the scanning of the perforation hole takes place in an infrared spectral range. The following realization namely underlies the invention:

On the evaluation of the hole position, in particular the extent of the hole rim is analyzed. The fact is utilized in this context that the perforation hole always appears brighter than the film in the transmitted light image. If, however, the film is illuminated by visible light, the detected brightness of the film stock or a generated picture element measured value will depend on the image information and the corresponding distribution of the colorings of the exposed motion picture film. If therefore the film brightness is not constant in the surroundings of the hole rim, this can result in unwanted irregularities in the determination of the position of the hole rim and thus of the position of the perforation hole on the scanning of the perforation hole in a visible spectral range.

It has been found that an irregular film brightness of this type along the hole rim can arise solely due to the transport of the motion picture film during the exposure in the camera. It is namely a fact that, during the intermitting transport of the film in the camera, sprocket drum teeth and registration pins dip into the perforation holes to correspondingly accelerate the motion picture film or to fix an individual image section in a defined position for a brief moment for exposure. The mechanical strain on the hole rim in particular effects a specific exposure (so-called pressure exposure of the film) at higher speeds.

If, in contrast, the scanning of the perforation hole takes place in an infrared spectral range, this disadvantageous effect is avoided. In the infrared namely, the colorings of the exposed film are substantially transparent so that the image content and in particular any pressure exposure of the film does not have a disadvantageous effect on the evaluation of the hole position.

A further disadvantage of the scanning of the perforation holes in the visible range consists of the fact that an adaptation of the illumination intensity to the respective film stock is required. The light absorption of the (unexposed) film stock itself is namely different for every film type. If therefore the illumination intensity is not set individually, there is a risk that the perforation holes are imaged in an over-exposed manner or that the film surrounding the perforation hole is imaged in too dark a manner, which would have an unfavorable effect on the accuracy of the evaluation of the hole position. On the use of an infrared illumination for the scanning of the perforation holes, in contrast, the explained variation of the absorption with different film types is lower than in the visible range. The avoidance of a disadvantageous over-exposure or under-exposure is therefore more simple and in particular no individual adaptation of the illumination intensity is required.

Finally, it has also been found that, when an infrared channel is used for the scanning of the perforation holes, it is even possible to distinguish between an inner rim and an outer rim of the respective perforation hole. The hole rim namely does not extend precisely in a straight line—in cross-section along a normal plane to the film plane—but it is slightly spherically or convexly arched with respect to the hole center in cross-section through the film stock so that it is possible to distinguish between an outer rim (boundary of the hole at the film surface) and an inner rim (maximum extent to the hole center) in plan view. The outer hole rim is, however, only recognizable in a scanning in the infrared. The accuracy of the positional evaluation can be increased even further by including the information on both the position of the outer hole rim and on the position of the inner hole rim.

It must still be noted with respect to the invention that the film transport can take place with a relatively low precision due to the optical detection of the respective position of the perforation holes so that higher transport speed are possible. Any image position errors which thereby arise can namely be corrected with reference to the detected hole positions.

It is in particular also possible with the film scanner in accordance with the invention to carry out a constant correction of the image position, for example also to control or correct the subsequent transport movement for the scanning of the next individual image section of the motion picture film on the basis of the image position correction signal generated in connection with the scanning of a specific individual image section of the motion picture film.

In accordance with an advantageous embodiment, the scanning of the perforation hole takes place at a wavelength of approximately 890 nm. At this wavelength, the position of a perforation hole for commercial film stock can be detected with particularly high accuracy.

Different possibilities exist for the realization of the infrared channel for the scanning of the perforation holes. The film scanner can in particular have its own infrared light source, for example one or more infrared light emitting diodes. Alternatively to this, a white light source can also be used which radiates both visible light (for the generation of the RGB scan images) and infrared light. A white light source of this type can have an infrared filter associated with it which is selectively introduced into the ray path—for example by means of a filter wheel—to carry out a pure infrared scanning. It is furthermore also possible to carry out a distinguishing of the spectral ranges on the receiving side, namely by using an image sensor which is only sensitive in the infrared or which is selectively or permanently provided with an infrared filter.

Provided that the distinction between the visible spectral ranges for the generation of the scanned images, on the one hand, and the infrared spectral range for the scanning of the perforation hole, on the other hand, is realized by the utilization of different light sources or by the use of filters which can be pivoted in, it is possible to use a single optoelectronic light receiver for the generation of both the RGB scanned images and the infrared image data. In this case, a light receiver is therefore used which detects both in the visible range and in the infrared, with the distinction between the different scan channels taking place by the use of different light sources or different filters.

It is, however, of advantage, if the infrared channel has its own image sensor which is made separately from an optoelectronic light receiver for the generation of the RGB scanned images. In this case, the respective image sensor can namely be made for the scanning of a film section which only contains the perforation hole or holes of the film to be viewed and is thus substantially smaller than that film section which is viewed by the light receiver for the generation of the RGB scanned images. On the other hand, the image sensor of the infrared channel can generate the infrared image data with a higher resolution than the RGB scanned images so that the perforation holes are detected with a particularly high precision.

The evaluation of the infrared image data with respect to the hole position can take place, for example, in that the determined position of the perforation hole is compared with a predetermined desired position, with the named image position correction signal corresponding to the deviation of the determined hole position from the desired position. In this context, different directions can naturally be taken into account, in particular two directions orthogonal to one another (X/Y deviation).

The correction of the image position on the basis of the generated image position correction signals can take place purely electronically. In this case, the individual picture element measured values of the visible scanned images (color channels) are displaced with respect to a predetermined matrix-like arrangement, with—in addition or alternatively to a purely translatory displacement—a rotation or a stretching or compressing of the image data along one or more directions also being able to be made to compensate for detected distortion of the scanned film stock. An electronic image position correction of this type can be carried out by means of the named evaluation device or by means of an additional correction device either inside the film scanner or externally.

Alternatively to an electronic correction of this type, the film scanner can have an adjustment device by means of which either the position of an individual image section of the motion picture film to be scanned is adjusted relative to the visual field of the light receiver used in accordance with the generated image position correction signals, for example by means of at least one piezoactor engaging at the film track (displacement and/or rotation of the film track). Or the optical properties of an optical receiving system of the film scanner are modified in accordance with the image position correction signals generated, for example by tilting of a plano-parallel transparent plate. A combination of these measures is also conceivable. A mechanical or optical correction of this type is generally carried out for that individual image section of the motion picture film which corresponds to or is spatially adjacent to the just scanned perforation hole. This correction is, however, preferably also taken into account for the next individual image section to be scanned.

In the case of the explained mechanical or optical correction of the image position, it is also advantageous for the scanning of the perforation holes by means of the infrared channel and for the corresponding correction measure by means of the named adjustment device to be carried out iteratively. In other words, the generation of the infrared image data and the respective subsequent adjustment of the position of the individual image section to be scanned or the adjustment of the imaging characteristics of the optical receiving system should optionally be repeated several times until a predetermined maximum deviation of the detected position of the perforation hole from a predetermined desired position has been reached. Only then does the actual scanning of the individual image section in the visible spectral ranges take place (RGB scanning). It is hereby ensured that an optimum image position has been set for each individual image section of the motion picture film before the scanned images of the visible spectral regions are generated.

It is furthermore preferred for the image position correction signal generated in connection with the scanning of a specific individual image section of the motion picture film also to be taken into account for a correction of a subsequent transport movement of the motion picture film for the purpose of the scanning of the next individual image section. For example, the film scanner can have a control device for this purpose which controls a transport device to make an intermittent transport movement of the motion picture film, with the previously generated image position correction signal being taken into account for each transport movement to position an individual image section in an ideal position right from the start and thus to make subsequent correction measures largely unnecessary.

In accordance with a further advantageous further development of the invention, the named infrared channel serves not only for the detection of the respective position of the perforation holes, but also for the optical scanning of at least one longitudinal edge of the film to be scanned in an infrared spectral range, with corresponding infrared image data being generated. These can be taken into account by the evaluation device in addition to the detected hole position for the generation of the image position correction signal.

The invention also relates to a method for the optical scanning of a motion picture film and for the generation of corresponding scanned images, wherein at least one perforation hole of the motion picture film is scanned in an infrared range and corresponding infrared image data are generated, with the infrared image data being evaluated with respect to the position of the perforation hole and at least one corresponding image position correction signal being generated.

Further embodiments of the invention are set forth in the dependent claims.

The invention will be explained in the following only by way of example with reference to the drawings.

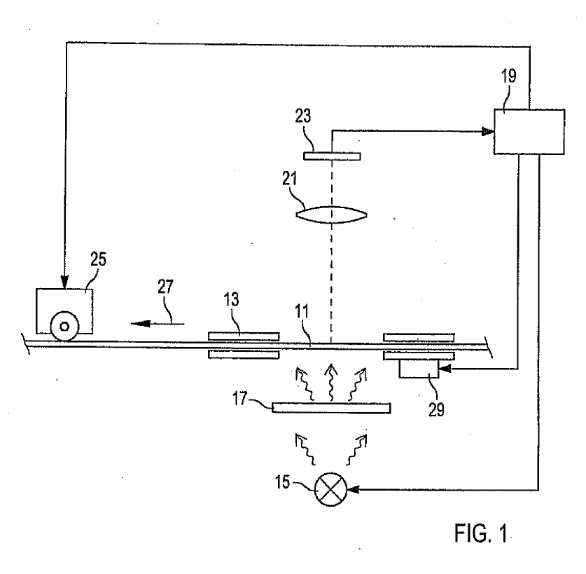

FIG. 1 shows the design of a first embodiment of a film scanner.

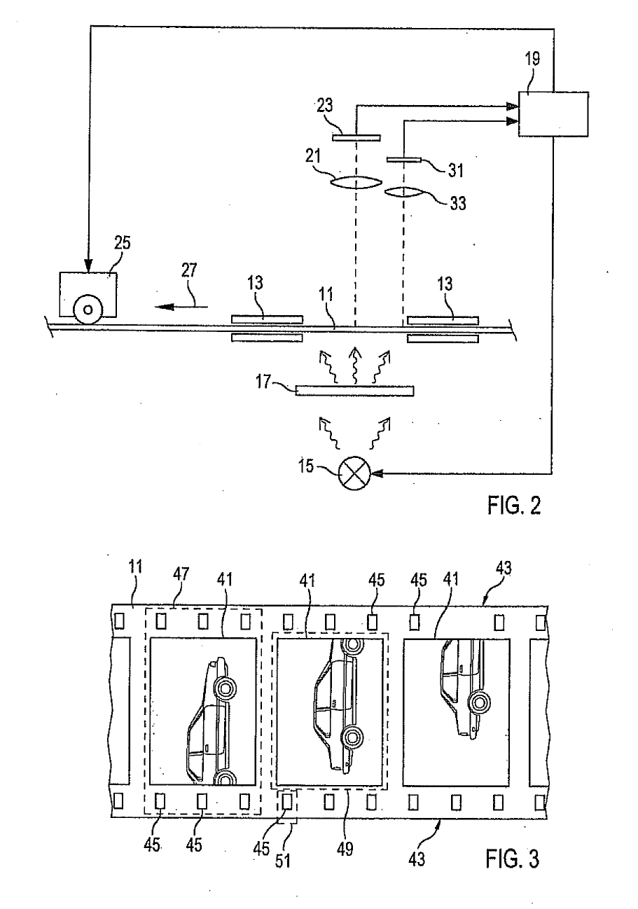

FIG. 2 shows the design of a second embodiment of a film scanner.

FIG. 3 shows a section of an exposed motion picture film with a plurality of sequential individual images.

FIG. 1 illustrates the design of a film scanner for the optical scanning of an exposed motion picture film 11, which is guided in a film track 13. The motion picture film 11 or an individual image section therefrom is illuminated selectively with red, blue, green or infrared light by means of a light source 15 and of a subsequent diffuser 17. For example, the light source 15 can be made as a white light source with an associated filter wheel or the light source 15 has a plurality of light emitting diodes with different emission spectra in accordance with the named spectral ranges. The selection of the respective required spectral range of the transmitted light or of the scanned channels formed thereby can take place by means of a control and evaluation circuit 19 which is connected to the light source 15.

An optical receiving system 21, which is shown by way of example as a converging lens, is arranged on the side of the motion picture film 11 disposed opposite the light source 15. The optical receiving system 21 images the individual image section of the motion picture film 11 to be scanned onto an optoelectronic light receiver 23 which is made, for example, as a CCD or CMOS receiver with a matrix-like arrangement of photoelectrical receiver elements. The receiver elements generate a respective picture element measured value in dependence on the light exposure, with the light receiver 23 being sensitive in both the visible range and in the infrared. The light receiver 23 is connected to an input of the control and evaluation circuit 19.

The optical scanning of the motion picture film 11 takes place in that it is moved along a transport direction 27 frame by frame by means of a drive device 25. In every position of rest of the motion picture film 11, the individual image section released by the film track 13 is sequentially illuminated with infrared light and then with red, green and blue light by a corresponding control of the light source 15. In this process, a scanned image having a matrix of picture element measured values is generated by means of the light receiver 23 for each scanned channel or spectral range and is read out by means of the control and evaluation circuit 19. Alternatively, a scanning taking place line-by-line is generally also possible.

The scanned images of the three color channels (red, green, blue) deliver the image information contained in the scanned individual image section, for example for a digital post-processing of the motion picture film 11. The named scanning in the infrared preferably takes place before the generation of the three scanned images in the visible range, with at least one such region of the motion picture film 11 being scanned in the infrared spectral range which contains a perforation hole, as will be explained in the following. The correspondingly generated infrared image data are evaluated by the control and evaluation circuit 19 with respect to the exact position of the detected perforation hole, with an image correction signal being generated in the case of a predetermined deviation of the determined hole position from a desired position which corresponds to the degree of this deviation. The control and evaluation circuit 19 controls a piezoelectric actor 29, which is arranged on the film track 13, on the basis of this image position correction signal. A slight time shift of the film track 13 and thus of the motion picture film 11 held therein is thereby effected, said film still being located in the said position of rest.

Due to the explained control of the piezoelectric actor 29, the motion picture film 11 and in particular the individual image section to be scanned are now exactly in the desired position. Only now are the scanned images of the visible spectral ranges generated for the respective individual image section. The control and evaluation circuit 19 then causes the drive device 25 to bring the motion picture film 11 along the transport direction 27 into the next position of rest in order to first be able to carry out the infrared scanning of the associated perforation hole for the next individual image section and then to again generate the scanned images of the color channels.

It is ensured on the basis of the explained image position correction that no unwanted image shift occurs with respect to the scanning of a plurality of sequential individual image sections of the motion picture film 11. The explained image position correction (scanning of the perforation hole in the infrared and corresponding adjustment of the film track 13) can optionally also be carried out several times one after the other for the same individual image section.

The special advantage of the use of an infrared channel consists—as already initially explained—of the fact that the position of an observed perforation hole, and in particular the position of the hole rim, can be detected with a particularly high accuracy irrespective of a possible optical exposure or of a pressure exposure of the hole surroundings.

Alternatively or additionally to the piezoelectric actuator 29, an adjustment device can also engage at the optical receiving system 21 or at the light receiver 23.

FIG. 2 shows an alternative aspect of a film scanner, with the same or like elements as in FIG. 1 being marked by the same reference numerals.

Unlike the embodiment in accordance with FIG. 1, the light receiver 23 only serves for the generation of the scanned images of the three color channels (red, green, blue). A separate infrared sensor 31 with an associated optical receiving system 33 is provided for the scanning of the perforation holes of the motion picture film 11 in the infrared and is likewise connected to an input of the control and evaluation circuit 19. The infrared image sensor 31 does not detect the actual individual image section of the motion picture film 11 with the image information contained therein, but is only directed to one or more of the perforation holes of the motion picture film 11 in order to determine the exact position of the respective perforation hole or to output corresponding infrared image data to the control and evaluation circuit 19. The infrared image sensor 31 therefore views a surface area of the motion picture film 11 which is considerably smaller than the individual image section detected by the light receiver 23. However, the infrared image sensor 31 has a higher resolution than the light receiver 23 so that the respective perforation hole is represented with a higher precision with a similar amount of data.

A further difference from the embodiment in accordance with FIG. 1 consists of the fact that no mechanical adjustment of the film track 13 by means of a piezoelectric actor or of any other adjustment device is provided. Instead, the control and evaluation circuit 19 uses the infrared image data of the infrared image sensor 31 for a purely electronic positional correction of the scanned images which are generated by the light receiver 23.

FIG. 3 shows a section of the exposed motion picture film 11 with a plurality of individual image sections 41 and the image information contained therein (e.g. passing automobile). A respective arrangement of rectangular perforation holes 45 is located between the arrangement of the individual image sections 41 and each longitudinal edge 43 of the motion picture film 11.

In FIG. 3, a possible image region 47 is shown which is detected by the light receiver 23 of the embodiment of FIG. 1, i.e. this light receiver 23 views both the individual image section 41 with the actual image information and the surrounding perforation holes 45.

Furthermore, FIG. 3 shows the image region 49 which is viewed by the light receiver 23 of the embodiment of FIG. 2. This image region 49 substantially corresponds to the individual image section 41 containing the image information. The infrared image sensor 31 additionally provided in the embodiment in accordance with FIG. 2, in contrast, views an image region 51 which only contains one single perforation hole 45 and a part of the longitudinal edge 43 of the motion picture film 11.

### REFERENCE NUMERAL LIST

11 motion picture film
13 film track
15 light source
17 diffuser
19 control and evaluation circuit
21 optical receiver system
23 light receiver
25 drive device
27 transport direction
29 piezoelectric actor
31 infrared image sensor
33 optical receiver system
41 individual image section
43 longitudinal edge
45 perforation hole
47 image region
49 image region
51 image region

1. A film scanner for the optical scanning of a motion picture film (11) and for the generation of corresponding scanned images, comprising:
an infrared channel for the optical scanning of at least one perforation hole (45) of the motion picture film in an infrared spectral range for the generation of corresponding infrared image data; and
an evaluation device (19) for the evaluation of the infrared image data with respect to the position of the perforation hole and for the generation of at least one corresponding image position correction signal.

2. A film scanner in accordance with claim 1, wherein the infrared passage is made for the optical scanning of the perforation hole (45) at a wavelength of approx. 890 nm.

3. A film scanner in accordance with claim 1, wherein the infrared passage has an infrared light source (15), a white light source with an associated infrared filter or an image sensor with an associated infrared filter.

4. A film scanner in accordance with claim 1, wherein the film scanner has an optoelectronic light receiver (23) for the generation of both the scanned images and the infrared image data.

5. A film scanner in accordance with claim 1, wherein the infrared channel has an image sensor (31) which is made separate from an optoelectronic light receiver (23) for the generation of the scanned images.

6. A film scanner in accordance with claim 5, wherein the infrared channel has a higher resolution with respect to the generation of the infrared image data than the light receiver (23) with respect to the generation of the scanned images; and/or in that the infrared channel is made for the scanning of a smaller surface of the motion picture film (11) than the light receiver (23).

7. A film scanner in accordance with claim 1, wherein the evaluation device (19) is made for the comparison of the determined position of the perforation hole (45) with a desired position, with the image position correction signal corresponding to a deviation of the determined position from the desired position.

8. A film scanner in accordance with claim 1, wherein one of the evaluation device (19) and an additional correction device of the film scanner is made for an electronic image position correction of the scanned images on the basis of the image position correction signal.

9. A film scanner in accordance with claim 1, wherein the film scanner furthermore has an adjustment device (29) by which at least one of the position of an individual image section (41) of the motion picture film (11) to be scanned, the position of a light receiver (23) and the imaging characteristics of an optical receiving system (21) of the film scanner can be adjusted on the basis of the image position correction signal.

10. A film scanner in accordance with claim 9, wherein the film scanner has a control device (19) by which the infrared passage and the adjustment device (29) can be controlled to make an iterative generation of the infrared image data and a respective subsequent adjustment of the position of at least one of the individual image section (41) to be scanned and of the imaging characteristics of the optical receiving system (21).

11. A film scanner in accordance with claim 1, wherein the film scanner has a control device (19) which is made for the scanning of sequential individual image sections (41) of the motion picture film for the control of an intermittent transport movement of the motion picture film, with the control device being configured to apply the image position correction signal generated in connection with the scanning of an individual image section (41) to a correction of the subsequent individual image section (41).

12. A film scanner in accordance with claim 1, wherein the infrared channel is made for the optical scanning of also at least one edge (43) of the film to be scanned in an infrared spectral range and for the generation of corresponding infrared image data.

13. A method for the optical scanning of a motion picture film (11) and for the generation of corresponding scanned images, comprising:
scanning at least one perforation hole (45) of the motion picture film in an infrared spectral range and generating corresponding infrared image data; and
evaluating the infrared image data with respect to the position of the perforation hole and generating at least one corresponding image position correction signal.

14. A method in accordance with claim 13, wherein the perforation hole (45) is scanned by means of an image sensor (31) which is made separately from an optoelectronic light receiver (23) for the generation of the scanned images.

15. A method in accordance with claim 13, wherein the determined position of the perforation hole (45) is compared with a desired position, with the image position correction signal corresponding to a deviation of the determined position from the desired position.

16. A method in accordance with claim 13, wherein the scanned images are electronically corrected on the basis of the image position correction signal, in particular by displacement of picture element measured values.

17. A method in accordance with claim 13, wherein at least one of the position of an individual image section (41) of the motion picture film to be scanned, the position of a light receiver (23) and the imaging characteristics of an optical receiving system (21) of the film scanner is adjusted on the basis of the image position correction signal, with the scanning of the individual image section (41) for the generation of the scanned images only taking place after the adjustment.

18. A method in accordance with claim 17, wherein the step of the generation of infrared images, the step of the generation of at least one corresponding image position correction signal and the step of the adjustment of at least one of the position of the individual image section (41), of the position of the light receiver (23) and of the imaging characteristics of the optical receiving system (21) are repeated for so long until a predetermined maximum deviation of the position of the perforation hole (45) is fallen below, wherein the scanning of the individual image section (41) for the generation of the scanned image only takes place thereafter.

19. A method in accordance with claim 13, wherein the image position correction signal generated in connection with the scanning of an individual image section (41) of the motion picture film is used for a correction of a subsequent transport movement of the motion picture film (11) for the scanning of the next individual image section (41).
